(19) United States
(12) Patent Application Publication
(10) Pub. No.: US 2013/0186969 A1
(43) Pub. Date: Jul. 25, 2013

(54) METHOD OF CONTROLLING THE OPERATION OF AN INTENSIFIER PISTON IN A FUEL INJECTOR

(71) Applicant: Alain Vandewalle, Naperville, IL (US)

(72) Inventor: Alain Vandewalle, Naperville, IL (US)

(73) Assignee: International Engine Intellectual Property Company ,LLC, Lisle, IL (US)

(21) Appl. No.: 13/825,844

(22) PCT Filed: Sep. 21, 2011
(86) PCT No.: PCT/US11/52484

§ 371 Date: Mar. 25, 2013

Related U.S. Application Data
(60) Provisional application No. 61/385,590, filed on Sep. 23, 2010.

(51) Int. Cl. F02M 51/06

(52) U.S. Cl. CPC F02M 51/061
USPC 239/5

(57) ABSTRACT

A method of controlling motion of a spool in a fuel injector is provided. A first current is provided on a close coil of the injector. A second current is initiated on an open coil of the injector while providing the first current. The first current is reversed after the second current reaches a saturation point. The first current is discontinued. The spool moves to the open position. The second current is discontinued with the spool in the open position. A third current is initiated on the close coil. A fourth current is provided on the open coil after initiating the third current. The fourth current on the open coil of the injector is reversed after the third current on the close coil reaches a saturation point. The fourth current is discontinued. The third current is discontinued with the spool in the closed position.

### TECHNICAL FIELD

The present disclosure relates to a fuel injector. More particularly, the disclosure relates to a method of operating an intensifier piston within a fuel injector.

### BACKGROUND

Fuel systems for modern diesel engines operate at ever increasing fuel injection pressures. One way to achieve these high fuel injection pressures is to utilize a hydraulically intensified fuel injection system. Such a system may utilize a high-pressure common rail system that provides fuel to each individual injector from a high-pressure accumulator, oftentimes referred to as the “rail” or “common rail.” The injector also receives a high-pressure hydraulic fluid, such as fuel, engine oil, or other hydraulic fluid, that is utilized to drive an intensifier piston, or other pressure intensifying system, to increase the pressure of the fuel that leaves the injector to the pressures required by modern diesel engines. Motion of the intensifier piston may be controlled by a spool valve or “spool” that allows hydraulic fluid preventing the motion of the intensifier piston to drain and the intensifier piston to move. Further, the spool is closed to allow hydraulic fluid to apply a force to the intensifier piston to place the intensifier piston in a position to be reactivated and increase the pressure of the fuel for a fuel injection. The motion of the spool is typically controlled by the application of a magnetic field to move the spool from a closed position to an open position, and from an open position back to a closed position. As injection invents have become more precisely controlled, the movement of the spool also needs to be more precisely controlled. Therefore, a need exists for an improved method of controlling an injector spool.

### SUMMARY

According to one process, a method of controlling motion of a spool in a fuel injector is provided. A first current is provided on a close coil of the injector. The first current providing a holding force on the spool of the fuel injector. A second current is initiated on an open coil of the injector while providing the first current on the close coil of the injector. The second current is adapted to move the spool to an open position. The first current on the close coil of the injector is reversed after the second current on the open coil reaches a saturation point. The first current is discontinued. The spool moves to the open position. The second current is discontinued with the spool in the open position. A third current is initiated on the close coil of the injector. The third current is adapted to move the spool to a closed position. A fourth current is provided on the open coil of the injection after initiating the third current on the close coil. The fourth current provides a holding force on the spool of the fuel injector. The fourth current on the open coil of the injector is reversed after the third current on the close coil reaches a saturation point. The fourth current is discontinued. The third current is discontinued with the spool in the closed position.

According to another process, a method of controlling motion of a spool in a fuel injector is provided. A first current is provided on a close coil of the injector. The first current provides a holding force on the spool of the fuel injector. A second current is initiated on an open coil of the injector while providing the first current on the close coil of the injector. The second current is adapted to move the spool to an open position. The first current on the close coil of the injector is reversed after the second current on the open coil reaches a saturation point. The first current is discontinued. The spool moves to the open position. The second current is discontinued with the spool in the open position.

According to a further process, a method of controlling motion of a spool in a fuel injector is provided. A first current is initiated on the close coil of the injector. The first current is adapted to move the spool to a closed position. A second current is provided on the open coil of the injection after initiating the first current on the close coil. The second current provides a holding force on the spool of the fuel injector. The second current on the open coil of the injector is reversed after the first current on the close coil reaches a saturation point. The second current discontinues. The first current is discontinued with the spool in the closed position.

### BRIEF DESCRIPTION OF THE DRAWINGS

FIG. 1 is a schematic view depicting current flow within a first coil and a second coil over a time period plotted in conjunction with movement of an injector spool over that same time period.

### DETAILED DESCRIPTION

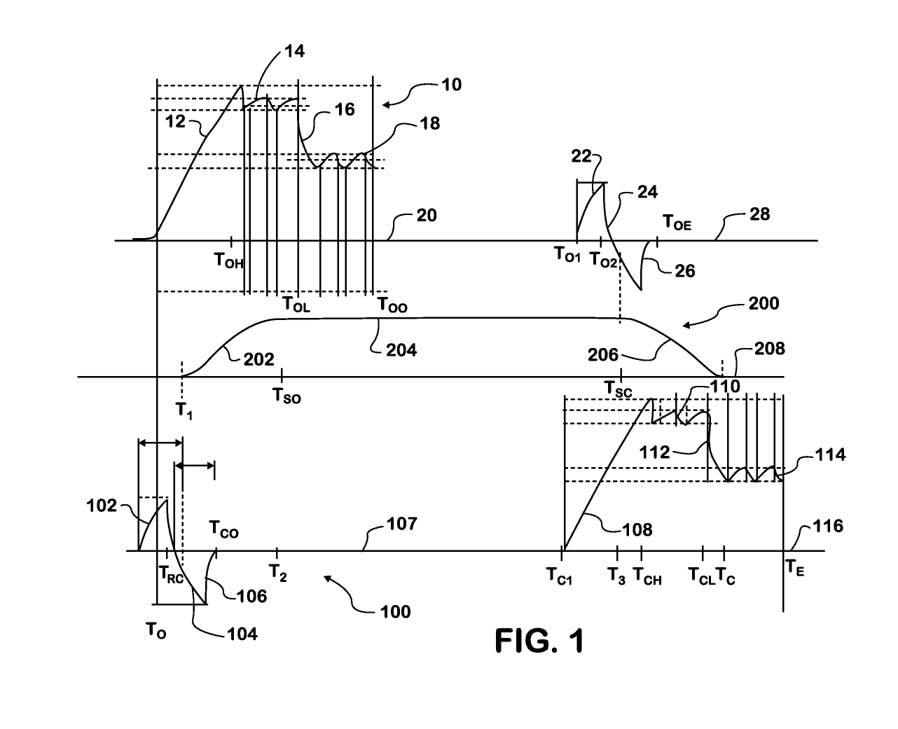

FIG. 1 depicts a plot of current provided to a first coil, or an open coil 10, current provided to a second coil, or a close coil 100, and movement of a spool 200 over a period of time. As can be seen, prior to a time Tₒ, a first current 102 is applied to the close coil. The first current 102 in the close coil acts to hold the spool in a closed position. At time Tₒ, a second current 12 is initiated on the open coil. Shortly after time Tₒ, the first current 102 is reversed at time T_{RC} to a reversed first current 104. The reversed first current 104 degausses the close coil. At time T₁, which follows time T_{RC}, the spool begins to move to an open position 202.

As the spool is moving to the open position 202, the reversed first current 104 is shut off as shown by current 106, such that by time T_{CO}, no current is passing through the close coil 107. At time T_{OH}, the first current reaches a maximum value and thereafter enters a high current region 14. After the open coil enters the high current region 14, the spool reaches an open position 204 at time T_{SO}. After the spool reaches the open position 204, the open coil enters a transition current region 16 disposed between the high current region 14 and a low current region 18. The transition current region 16 begins at a time T_{OL}, which follows the time T_{SO} when the spool reaches the open position 204. The open coil has the low current 18 applied until time T_{OO}, when current to the open coil is discontinued, and the current goes to zero, as shown in the zero current region 20 of the open coil.

With the spool still in the open position 204, the close coil receives a third current 108 that begins at a time T_{CI}. Shortly after the time T_{CI}, a fourth current 22 is applied to the open coil. The fourth current holds the spool in the open position 204 until the third current 108 causes a magnetic field saturation point to be reached on the close coil. The fourth current 22 is reversed at time T_{OR} to a reversed third current 24. The reversed fourth current 24 degausses the open coil. At time T_{sc}, which follows time T_{OR}, the spool begins to move to a close position 206.

As the spool is moving from the open position to the closed position 206, the reversed fourth current 24 is shut off as shown by current 26, such that by time T_{OE}, no current is passing through the open coil 28. At time T_{CH}, the third current reaches a maximum value and thereafter enters a high current region 110. After the close coil enters the high current region 110, the spool approaches a closed position 208 at time T_{C}. Before the spool reaches the closed position 208, the close coil enters a transition current region 112 disposed between the high current region 110 and a low current region 114. The transition current region 112 begins at a time T_{CL}, which is followed by the time T_{C} when the spool reaches the closed position 208. The close coil has the low current 114 applied until time T_{E}, when current to the close coil is discontinued, and the current goes to zero, as shown in the zero current region 116 of the open coil.

Thus, the application of current to the close coil prior to the application of current to the open coil, when the spool is to be placed into an open position, keeps the spool in the closed position until such time as the magnetic field on the open coil is optimized The spool may then more quickly be moved to the open position. Similarly, the application of current to the open coil prior to the application of current to the close coil, when the spool is to be placed into a closed position, keeps the spool in the open position until such time as the magnetic field on the close coil is optimized. The spool may then more quickly be moved to the closed position.

What is claimed is:

1. A method of controlling motion of a spool in a fuel injector comprising:
providing a first current on a close coil of the injector, the first current providing a holding force on the spool of the fuel injector;
initiating a second current on an open coil of the injector while providing the first current on the close coil of the injector, the second current adapted to move the spool to an open position;
reversing the first current on the close coil of the injector after the second current on the open coil reaches a saturation point;
discontinuing the first current;
moving the spool to the open position;
discontinuing the second current with the spool in the open position;
initiating a third current on the close coil of the injector, the third current adapted to move the spool to a closed position;
providing a fourth current on the open coil of the injection after initiating the third current on the close coil, the fourth current providing a holding force on the spool of the fuel injector;
reversing the fourth current on the open coil of the injector after the third current on the close coil reaches a saturation point;
discontinuing the fourth current; and
discontinuing the third current with the spool in the closed position.

2. The method of controlling motion of a spool in a fuel injector of claim 1, wherein reversing the first current on the close coil degausses the close coil.

3. The method of controlling motion of a spool in a fuel injector of claim 1, wherein the first current is less than the second current.

4. The method of controlling motion of a spool in a fuel injector of claim 1, wherein the third current is greater than the fourth current.

5. The method of controlling motion of a spool in a fuel injector of claim 1, wherein the second current has a high current portion and a low current portion.

6. The method of controlling motion of a spool in a fuel injector of claim 5, wherein the low current portion being greater than the first current.

7. The method of controlling motion of a spool in a fuel injector of claim 1, wherein the third current has a high current portion and a low current portion.

8. The method of controlling motion of a spool in a fuel injector of claim 7, wherein the low current portion being greater than the fourth current.

9. The method of controlling motion of a spool in a fuel injector of claim 1, wherein reversing the fourth current on the close coil degausses the open coil.

10. A method of controlling motion of a spool in a fuel injector comprising:
providing a first current on a close coil of the injector, the first current providing a holding force on the spool of the fuel injector;
initiating a second current on an open coil of the injector while providing the first current on the close coil of the injector, the second current adapted to move the spool to an open position;
reversing the first current on the close coil of the injector after the second current on the open coil reaches a saturation point;
discontinuing the first current;
moving the spool to the open position; and
discontinuing the second current with the spool in the open position.

11. The method of controlling motion of a spool in a fuel injector of claim 10, wherein reversing the first current on the close coil degausses the close coil.

12. The method of controlling motion of a spool in a fuel injector of claim 10, wherein the first current is less than the second current.

13. The method of controlling motion of a spool in a fuel injector of claim 10, wherein the second current has a high current portion and a low current portion.

14. The method of controlling motion of a spool in a fuel injector of claim 13, wherein the low current portion being greater than the first current.

15. A method of controlling motion of a spool in a fuel injector comprising:
initiating a first current on the close coil of the injector, the first current adapted to move the spool to a closed position;
providing a second current on the open coil of the injection after initiating the first current on the close coil, the second current providing a holding force on the spool of the fuel injector;
reversing the second current on the open coil of the injector after the first current on the close coil reaches a saturation point;
discontinuing the second current; and
discontinuing the first current with the spool in the closed position.

16. The method of controlling motion of a spool in a fuel injector of claim 15, wherein reversing the second current on the open coil degausses the open coil.

17. The method of controlling motion of a spool in a fuel injector of claim 15, wherein the second current is less than the first current.

18. The method of controlling motion of a spool in a fuel injector of claim 15, wherein the first current has a high current portion and a low current portion.

19. The method of controlling motion of a spool in a fuel injector of claim 13, wherein the low current portion being greater than the second current.
